(19) United States
(12) Patent Application Publication
(10) Pub. No.: US 2024/0405420 A1
(43) Pub. Date: Dec. 5, 2024

(54) MECHANISM TYPE ANTENNA FOR TRACKING STARLINK SATELLITE

(71) Applicant: AZURE SHINE INTERNATIONAL INC., TAOYUAN CITY (TW)

(72) Inventor: WEN CHAO SHEN, TAOYUAN CITY (TW)

(21) Appl. No.: 18/328,599

(22) Filed: Jun. 2, 2023

(51) Int. Cl. H01Q 3/08; H01Q 15/24

(52) U.S. Cl. CPC H01Q 3/08; H01Q 15/242

(57) ABSTRACT

The invention relates to a mechanism type antenna for tracking starlink satellite, including a horizontal shaft adjustment device, arranged on a base; a set of disk antenna 180° rotational symmetrically arranged on the left and right sides above the horizontal shaft adjustment device, which are respectively driven by a first arm and a second arm, to achieve synchronous reverse cross swing; a starlink satellite orbit adjustment device, arranged on a swivel seat; so as to achieve handover tracking of low orbit starlink satellites, an elevation angle adjustment device and a set of polarization adjustment device; whereby using two disk antennas swing in opposite direction to form an antenna which can quickly handover to new target satellites, which can replace the two independent conventional antennas used by VSTA and the electronically phased array antenna of starlink system, so as to achieve cost down and reduce failure rate.

### BACKGROUND OF THE INVENTION

### 1. Field of the Invention

The invention relates to an antenna for starlink satellite, especially to one that using single mechanism type antenna to replace two independent antennas of conventional VSTA antenna, and to replace phased array electronic antenna device of starlink system.

### 2. Description of the Related Art

With the advancement of low earth orbit satellite technology, LEO for short, the application using LEO to provide communication services is becoming more and more popular. But LEO is different from traditional artificial satellites, most artificial satellites are synchronous satellites and work in Geosynchronous Orbit, GSO. In GSO, the satellite is stationary relative to the earth, so the ephemeris adjustment and the alignment of the ground communication station are relatively easy. The disadvantage is that the distance is long and the power required for communication is high, so a heavy-duty antenna with large transceiver power and large volume is required.

Referring to the FIG. 1A, a conventional LEO antenna 80 of INTELLIAN TECHNOLGIES Inc., this belongs to Very Small Aperture Terminal, VSAT, US patent number US2021/0066778A1, the antenna 80 includes an elevation angle adjustment device 81, an oblique angle adjustment device 82, an azimuth angle adjustment device 83; Referring to the FIG. 1B, since the LEO travels very fast in its orbit, the user equipment often requires handover to a new target satellite, in other words, it requires at least two antennas 80a and 80b, the first antenna 80a and the second antenna 80b track the first satellite S1 from point b to point c, as shown by the solid line \textcircled{1} and the dotted line \textcircled{2} in the figure, when the second satellite S2 travels closing to the point a, the second antenna 80b is back to the point a to track the second satellite S2, as shown by the solid line \textcircled{3}, then when the second satellite S2 travels to the point b, beside the second antenna 80b keeps tracking the second satellite S2, as shown by the dotted line \textcircled{4}, the first antenna 80a also back to the point b to track the second satellite S2, as shown by the dotted line \textcircled{5}, so on and so forth, therefore the two antennas 80a, 80b keep repeating handover. Thus, VSAT of the INTELLIAN TECHNOLGIES requires two independent antennas 80a and 80b, it not only increase the cost, but also the operation of repeating handover of two independent antennas are complicated, which is disadvantage. The type of patent is also disclosed in US patent US20210399416A1 and US20190157765A1.

In low orbit satellite related technologies, the antenna 90 used by SpaceX's starlink system is shown in FIG. 2, the starlink client antenna is not connected to a single satellite during communication, but is aligned with the entire satellite flight track. Therefore, a phased array antenna board 91 is required instead of the traditional beam satellite antenna 80 shown in FIG. 1, because the phased array antenna board 91 supports beamforming and is easier to align satellites. The back of the phased array antenna board 91 has a motor device 92, and the starlink antenna 90 also includes a power supply 93 and a router 94.

Phased array technology uses multiple antenna elements to control the radiation pattern or beam by changing the relative phase of each element, and connects the antenna elements using a microwave transmission line and a power divider system. In the phased array antenna 90 design, using interference or “beamforming” between two or more radiating signals to steer the direction of the transmitted beam. The antenna board 91 achieves beamforming by adjusting the phase difference between the drive signals sent to each transmitter in the array. US20180241122 of SpaceX disclosed some mechanism structure of the phased array antenna, the antenna has a motor with automatic mechanical adjustment capability. Also, this motor adjustment only has the mechanical adjustment capability in one direction. Basically, it can sure that this motor adjustment is only used to adjust the elevation angle. The terminal can automatically adjust the elevation angle according to its own longitude and latitude geographic location, and adopts the phase array to achieve realizes automatic tracking of sending and receiving signals.

However, the antenna of starlink system usually adopt electronically scanned array, the cost of using electronically scanned array is high, and the failure rate is also high, so it is important to find a way to achieve cost down and reduce failure rate.

Thus, the present invention is for solving the above-mentioned problems of antenna of starlink system by using traditional satellite receiving antenna.

### SUMMARY OF THE INVENTION

It is a primary objective of the present invention to provide a mechanism type antenna for tracking starlink satellite which using a single receiving device that having two disk antennas that 180° rotational symmetrically swing in opposite direction to form a mechanism type antenna which can quickly handover to new target satellites, which can replace the two independent conventional antennas currently used by VSTA and the electronically phased array antenna of starlink system, so as to achieve cost down and reduce failure rate.

In order to achieve the above objectives, the present invention including: a base, having a center shaft arranged vertically on the base; a horizontal shaft adjustment device, arranged on the base, including: a swivel seat, the bottom of the swivel seat is connected to a first belt wheel and set on the center shaft; a first motor, arranged on the swivel seat, a rotate shaft of the first motor drives the first belt wheel through a first driving belt, and then drives the swivel seat to rotate clockwise or counterclockwise on the central shaft; a starlink satellite orbit adjustment device, arranged on the swivel seat, a vertical rack, a first shaft seat and a second shaft seat arranged on the longitude direction of front end and rear end of the vertical rack, on the first shaft seat and the second shaft seat having a first rotation shaft and a second shaft respectively, then the first rotation shaft and the second shaft are connected to each other by a bearing seat, the longitude length is larger than the transverse width of the bearing seat, making the bearing seat enable to swing left and right along with the rotation of the second shaft; moreover, at the middle of the bearing seat having a transverse shaft, the left and right ends of the transverse shaft set trough the bearing seat and fixed on the bearing seat, then respectively connect to a second belt wheel and a third belt wheel; a set of disk antenna, formed by a first disk antenna and a second disk antenna which are 180° rotational symmetrically arranged on the left and right sides of the bearing seat, which are respectively drove by a first arm and a second arm, the first arm and the second arm are respectively connected and secured to a second belt wheel and a third belt wheel, the second belt wheel and the third belt wheel are drove by a second motor and a third motor through a second driving belt and a third driving belt, so as to make the first arm and the second arm which are respectively connected and secured on the second belt wheel and the third belt wheel to rotate on the left and right ends of the transverse shaft, then further drive the first disk antenna and the second disk antenna swing forth and back on the bearing seat, so as to achieve handover tracking to low orbit satellite; an elevation angle adjustment device, arranged a vertical rack, including: a fourth motor, a fourth belt wheel arranged on the second rotation shaft, and the fourth motor drives the fourth belt wheel through a fourth driving belt, and then with the first rotation shaft and second rotation shaft as center drives the bearing seat swing left and right to adjust the elevation angle of the first disk antenna and the second disk antenna; and a set of polarization adjustment device, formed by a first polarization adjustment device and a second polarization adjustment device which are respectively arranged above the first arm and the second arm, wherein the first polarization adjustment device includes: a supporting seat, which is a hollow body and the inner end is fixed on the upper end of the first arm; a fifth motor, arranged at the bottom of the supporting seat, a rotating shaft of the fifth motor is extended into the supporting seat, a fifth driving belt drives a fifth belt wheel, the fifth belt wheel is able to rotate on a shaft center, and its upper end protrudes above the supporting seat, then drives the first disk antenna to rotate; and the second polarization adjustment device which has the same structure as the first polarization adjustment device, and is used to drive the second disk antenna to rotate; Whereby achieve a mechanism type antenna for tracking starlink satellite, which can control the first disk antenna and the second disk antenna to achieve handover tracking of low orbit starlink satellites, and can simultaneously adjusting the horizontal shaft, the elevation angle and the polarization for receiving the signal from the starlink satellite.

Also, the second motor and the third motor are respectively arranged on the first arm and the second arm.

Also, the fourth motor is arranged on the second shaft seat.

Also, the first disk antenna and the second disk antenna include: rectangular, circular or elliptical type.

Also, the first disk antenna and the second disk antenna further include an electronic equipment for receiving starlink satellite signals, which including a receiver, a controller and a memory, using the controller to process the data received from the receiver and the data storage in the memory, and then produces the control signal that is used to control the mechanism type antenna for tracking starlink satellite to respectively control the first motor, the second motor, the third motor, the fourth motor and the fifth motor to rotate, so as to control the elevation angle, oblique angle, azimuth angle and polarization of the mechanism type antenna for tracking starlink satellite.

Whereby the present invention uses a single receiving device that having two disk antennas that 180° rotational symmetrically swing in opposite direction to form a mechanism type antenna which can quickly handover to new target satellites, which can replace the two independent conventional antennas currently used by VSTA and the electronically phased array antenna of starlink system, so as to achieve cost down and reduce failure rate.

### BRIEF DESCRIPTION OF THE DRAWINGS

FIG. 1A is a perspective view showing the structure of the low earth orbit satellite antenna of the prior art;

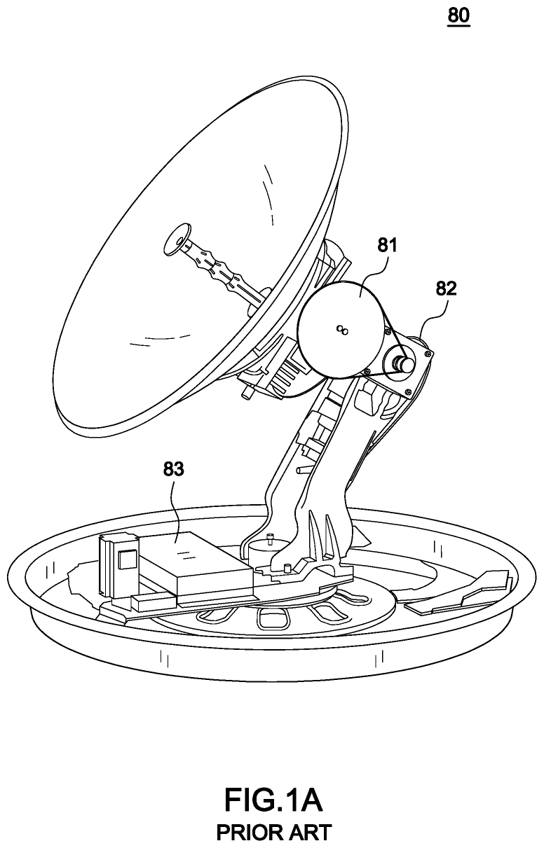

FIG. 1B is a schematic diagram illustrating the application of the low earth orbit satellite antenna of the prior art;

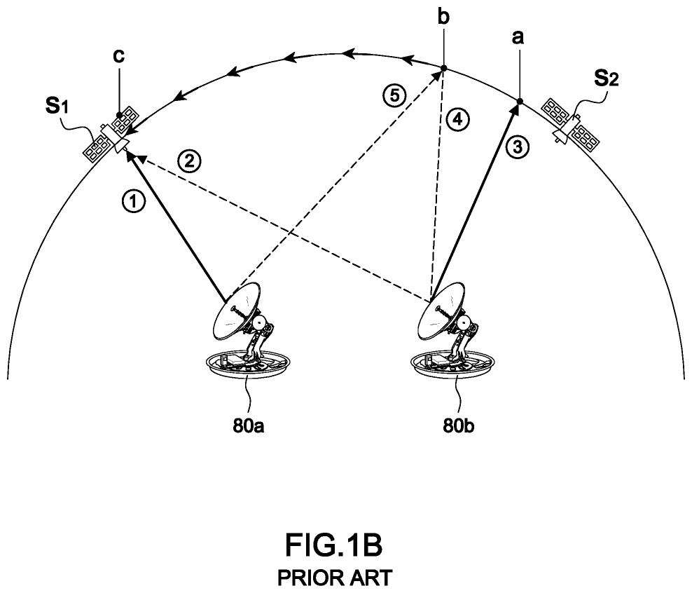

FIG. 2 is a schematic diagram illustrating the application of the antenna of the starlink system of the prior art;

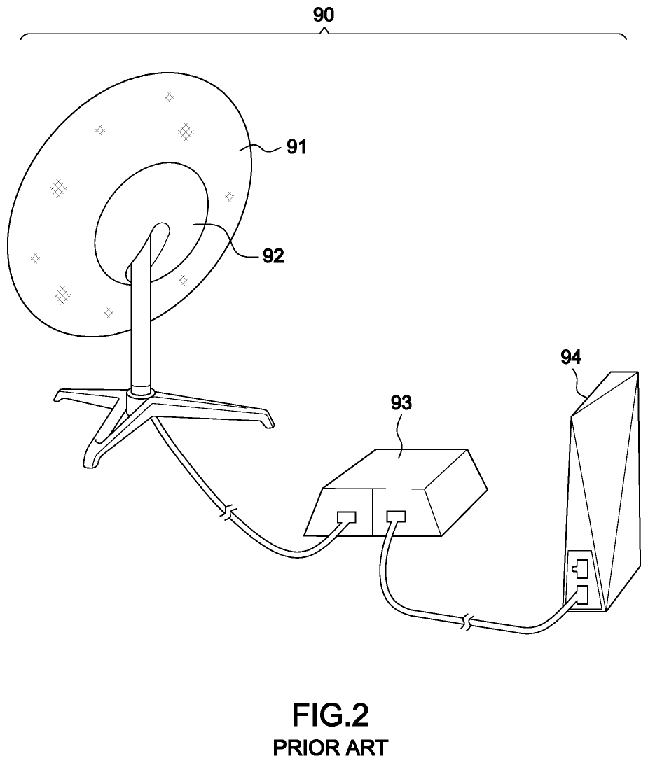

FIG. 3 is a perspective view showing the structure of a preferred embodiment of the present invention;

FIG. 4 is a zoom-in of the main structure of the FIG. 3;

FIG. 5 is a perspective view of the elevation angle adjustment device of the present invention;

FIG. 6A is a side view of a preferred embodiment of the present invention, which shows that the first disk antenna aligned with the starlink satellite orbit B;

FIG. 6B is a side view of a preferred embodiment of the present invention, which shows that the second disk antenna aligned with the starlink satellite orbit B;

FIG. 6C is a side view of the horizontal shaft adjustment device of the present invention;

FIG. 7A is a top view of a preferred embodiment of the present invention, which showing the disk antenna can do horizontal shaft adjustment of track A;

FIG. 7B is a top view of a preferred embodiment of the present invention, which showing the disk antenna can counterclockwise adjust with an angle θ;

FIG. 8A is a sectional view showing the structure of the polarization adjustment device of the present invention;

FIG. 8B is a top view of the polarization adjustment device of the present invention;

FIG. 9 is a perspective view of another preferred embodiment of the present invention;

FIG. 10 is a schematic diagram illustrating the control application of the antenna control device.

### DETAILED DESCRIPTION OF THE PREFERRED EMBODIMENT

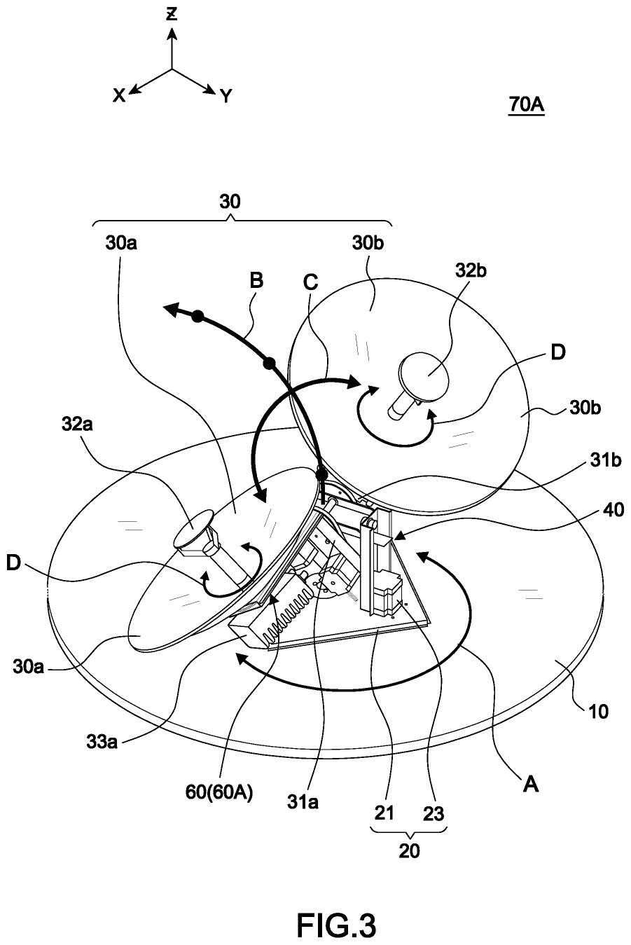

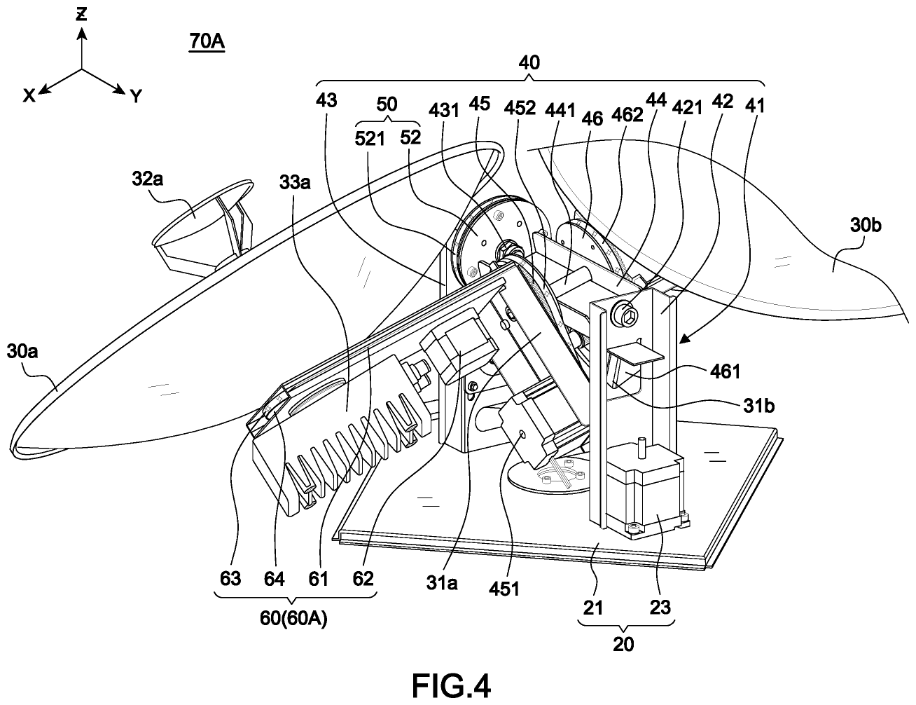

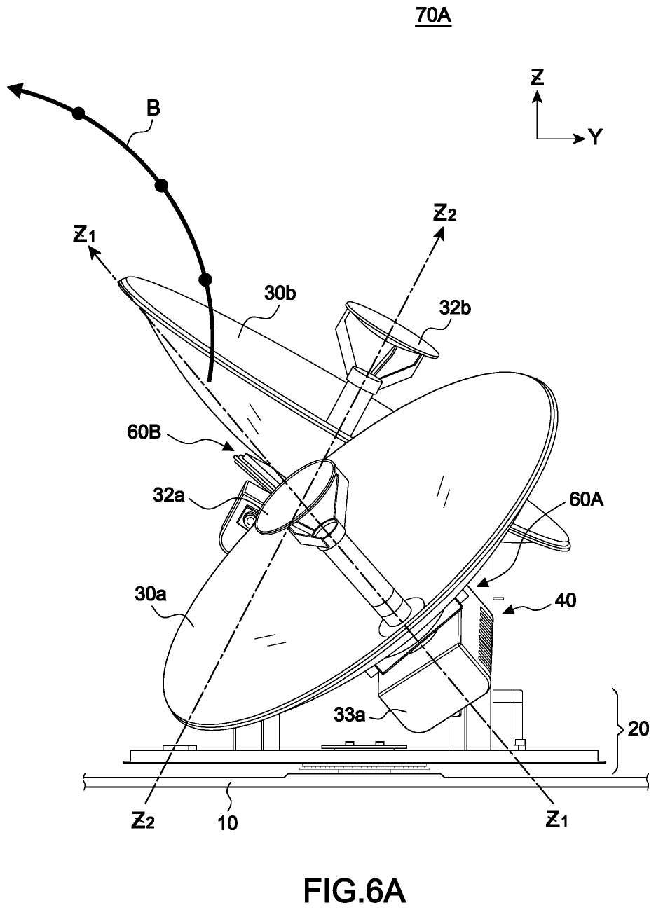

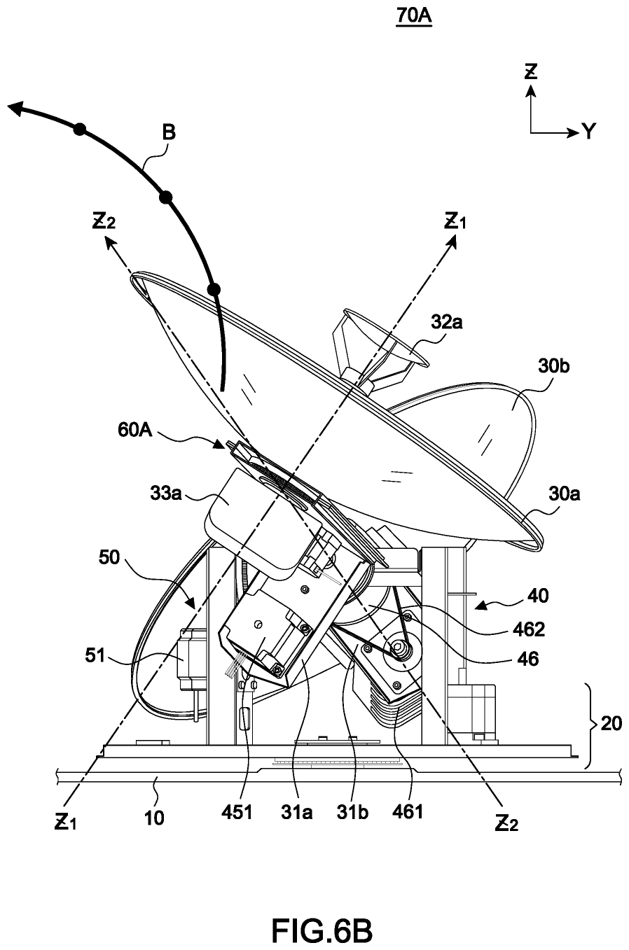

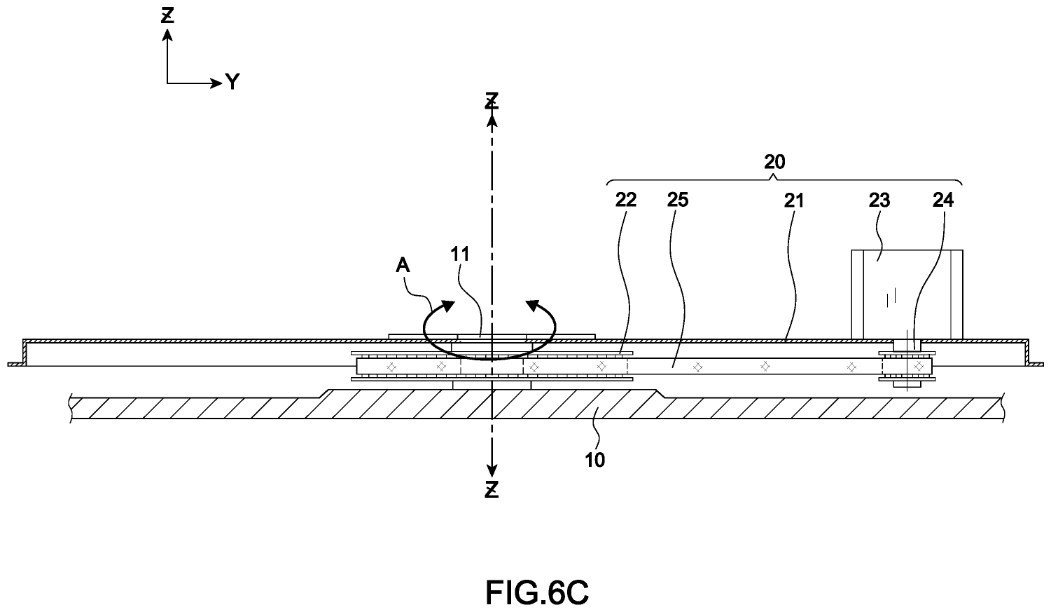

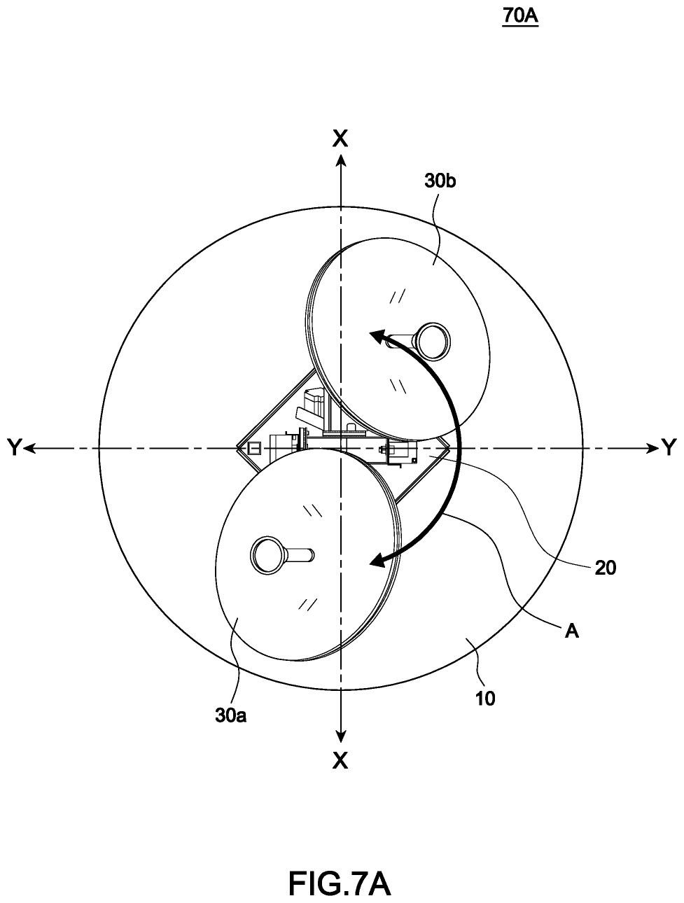

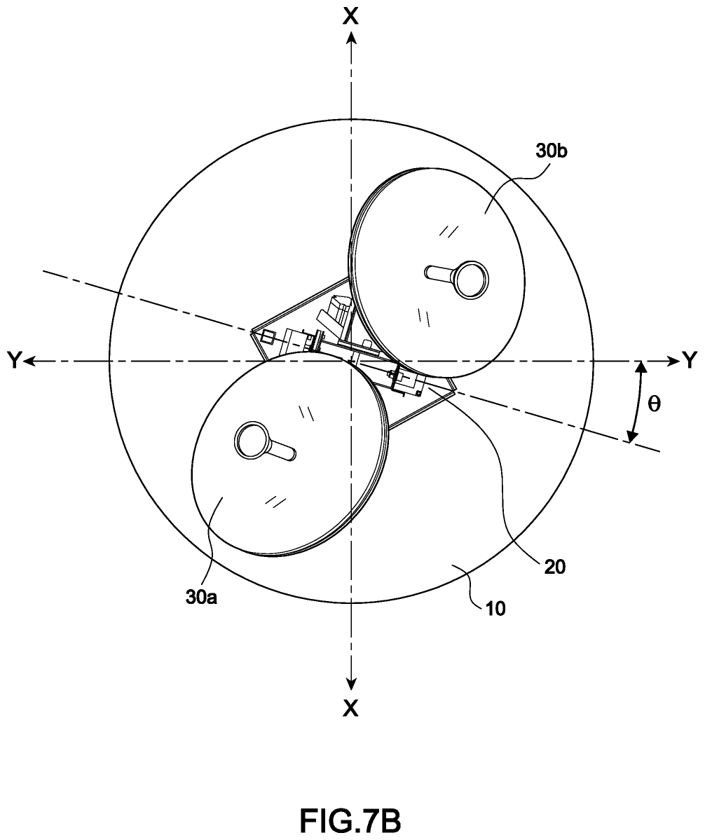

Referring to FIGS. 3˜10, a mechanism type antenna for tracking starlink satellite 70A of a preferred embodiment, comprising: a base 10, having a center shaft 11, Z axis showing in FIG. 6C, arranged vertically on the base 10; a horizontal shaft adjustment device 20, arranged on the base 10, as showing in FIG. 4 and FIG. 6C, including: a swivel seat 21, the bottom of the swivel seat 21 is connected to a first belt wheel 22 and set on the center shaft 11; a first motor 23, arranged on the swivel seat 21, a rotate shaft 24 of the first motor 23 drives the first belt wheel 22 through a first driving belt 25, and then drives the swivel seat 21 to rotate clockwise or counterclockwise on the central shaft 11; the driving belt and the belt wheel can be formed by chain or chain wheel, but the present invention is not limited to this application. In this embodiment, the swivel seat 21 is an rectangleplate body, but it is not limited thereto, it is rotatably mounted on the central shaft 11 and driven by the first motor 23 to drive rotation for making a disk antenna 30 on the swivel seat 21 achieves horizontal shaft adjustment, as track A showing in the drawing, or achieves azimuth angle θ adjustment of the mechanism type antenna for tracking starlink satellite 70A from FIG. 7A to FIG. 7B. This is the first mean of the present invention.

Referring to FIGS. 3˜5, a starlink satellite orbit adjustment device 40 which arranged above the swivel seat 21, including a vertical rack 41, a first shaft seat 42 and a second shaft seat 43 arranged on the longitude direction (Y axis) of front end and rear end of the vertical rack 41, on the first shaft seat 42 and the second shaft seat 43 having a first rotation shaft 421 and a second shaft 431 respectively, then the first rotation shaft 421 and the second shaft 431 are connected to each other by a bearing seat 44, the longitude length (Y axis) is larger than the transverse width (X axis) of the bearing seat 44, making the bearing seat 44 enable to swing left and right along with the rotation of the second shaft 431; in this embodiment, the bearing seat 44 is a U shape structure, but not limit to this application. At the middle of the bearing seat 44 having a transverse shaft 441 (X axis), the left and right ends of the transverse shaft 441 set trough the bearing seat 44 and fixed on the bearing seat 44, then respectively connect to a second belt wheel 45 and a third belt wheel 46, the transverse shaft 441 becomes the center shaft of the second belt wheel 45 and the third belt wheel 46, so the second belt wheel 45 and the third belt wheel 46 enable to rotate on the transverse shaft 441.

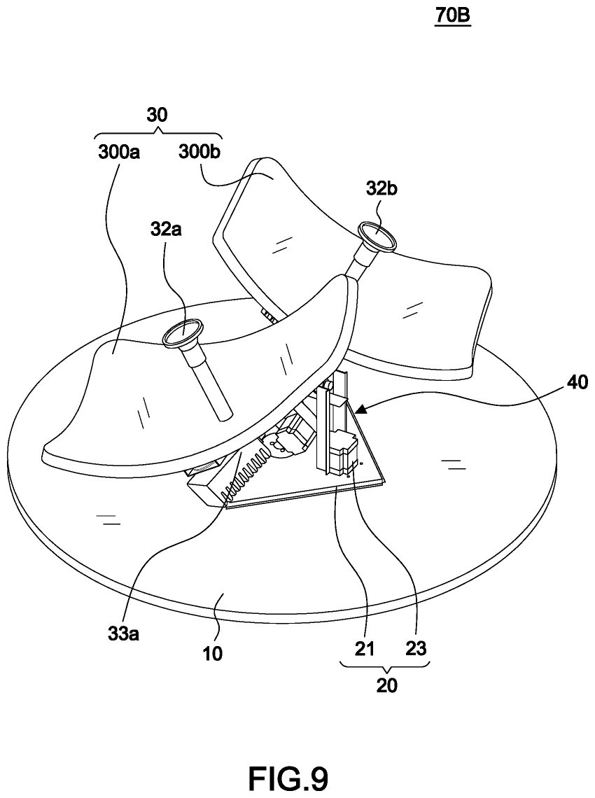

A set of disk antenna 30, formed by a first disk antenna 30a and a second disk antenna 30b which are 180° rotational symmetrically arranged on the left and right sides above the bearing seat 44, which are respectively driven by a first arm 31a and a second arm 31b, the first arm 31a and the second arm 31b are respectively connected and secured on the second belt wheel 45 and the third belt wheel 46, the second belt wheel 45 and the third belt wheel 46 are further respectively drove by a second motor 451 and a third motor 461 through a second driving belt 452 and a third driving belt 462, so as to make the first arm 31a and the second arm 31b which are respectively connected and secured on the second belt wheel 45 and the third belt wheel 46 to rotate on the left and right ends of the transverse shaft 441, then further drive the first disk antenna 30a and the second disk antenna 30b swing forth and back on the bearing seat 44, so as to achieve handover tracking to low orbit satellite; in this embodiment, the second motor 451 and the third motor 461 are respectively arranged on the first arm 31a and the second arm 31b, moreover, in this embodiment, the first disk antenna 30a and the second disk antenna 30b are circular type, but not limited to this; Referring to FIG. 9, the disk antenna 30 including rectangular type 300a, 300b, or other elliptical type is also acceptable. Moreover, the first disk antenna 30a and the second disk antenna 30b include a waveguide 32a, 32b and an electronic equipment 33a for receiving starlink satellite signals, the electronic equipment includes a, a feeder, a low noise amplifier or a down converter. These electronic equipments 33a belong to prior art, so they are not mentioned in detail here.

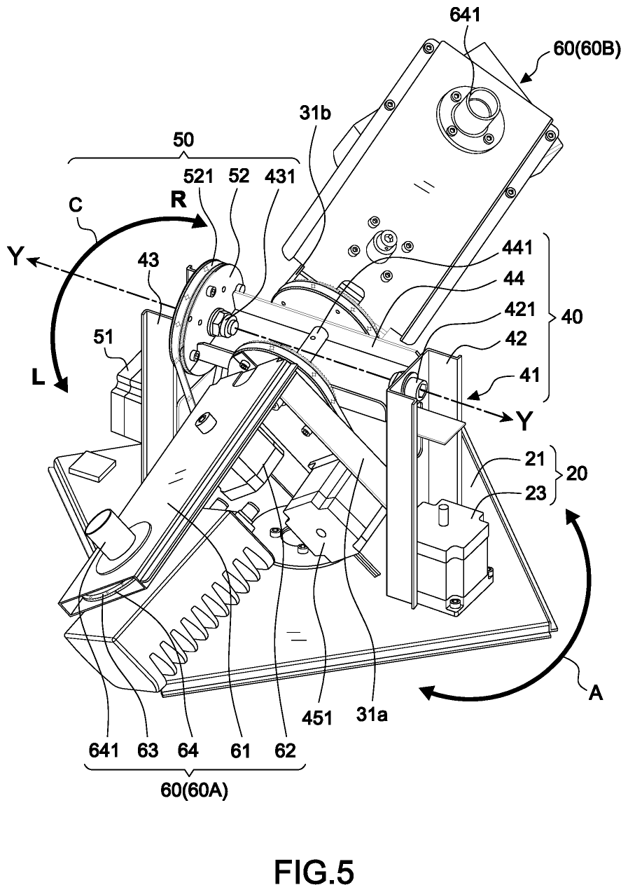

Referring to FIG. 5, an elevation angle adjustment device 50, arranged on the vertical rack 41, including: a fourth motor 51, a fourth belt wheel 52 arranged on the second rotation shaft 431, and the fourth motor 51 drives the fourth belt wheel 52 through a fourth driving belt 521, and then with the first rotation shaft 421 and second rotation shaft 431 as center drives the bearing seat 44 swing left and right to adjust the elevation angle C of the first disk antenna 30a and the second disk antenna 30b. In this embodiment, the fourth motor 51 is mounted on the second shaft seat 43.

In this embodiment, utilize the second motor 451 and the third motor 461 to drive the second belt wheel 45 and the third belt wheel 45 and then drive the first disk antenna 30a and the second disk antenna 30b on the left and right ends of the transverse shaft 441 in opposite directions, so as to achieve handover tracking to low orbit satellite. as shown in FIG. 6A and FIG. 6B; FIG. 6A presents the first disk antenna 30a (Z1 axis) aligning the satellite of the starlink orbit B, FIG. 6B presents the second disk antenna 30b (Z2 axis) aligning the satellite of the starlink orbit B. Whereby the directivity of the first disk antenna 30a and the second disk antenna 30b drove by the first arm 31a and the second arm 31b cross between Z1˜Z2, so as to align the satellite of the starlink satellite orbit B, to achieve handover. This is the second mean of the present invention.

Referring to FIG. 5, when the bearing seat 44 is drove by the fourth motor 51 and the fourth belt wheel 52 to swing left and right, the first disk antenna 30a and the second disk antenna 30b are still able to be drove by the second motor 451 and the third motor 461, which does not affect the operation of the starlink satellite orbit adjustment device 40 at all. The “elevation angle adjustment” here can be left and right inclined angle adjustment, for example: adjust to left inclined angle or adjust to right inclined angle. Furthermore, the starlink satellite orbit adjustment device 40 and the elevation angle adjustment device 50 are cleverly combined on the swivel seat 21, so that the configuration and operation of the overall space are very smooth. This is the third means of the present invention.

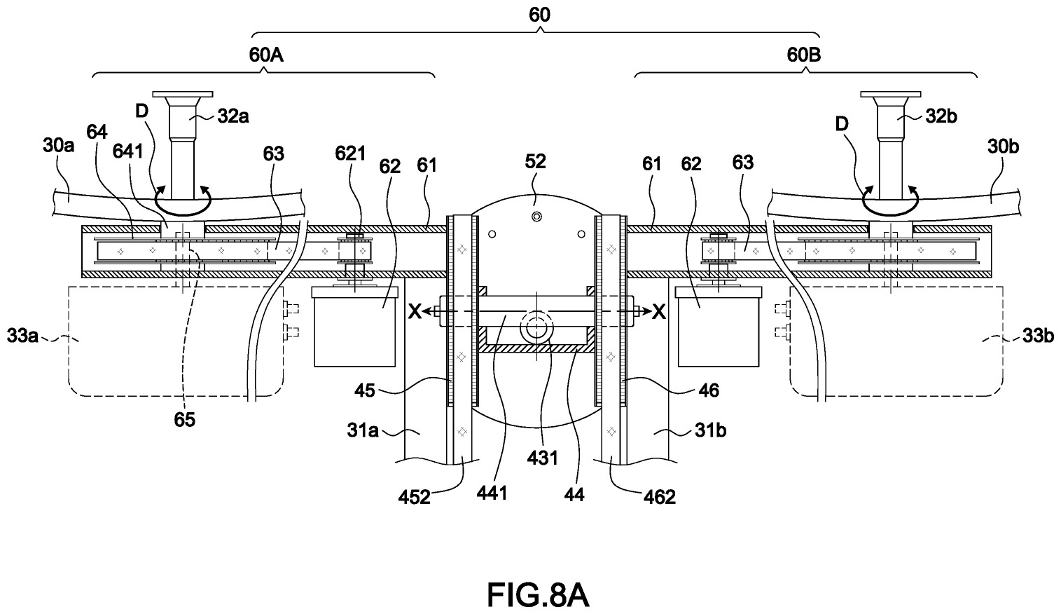

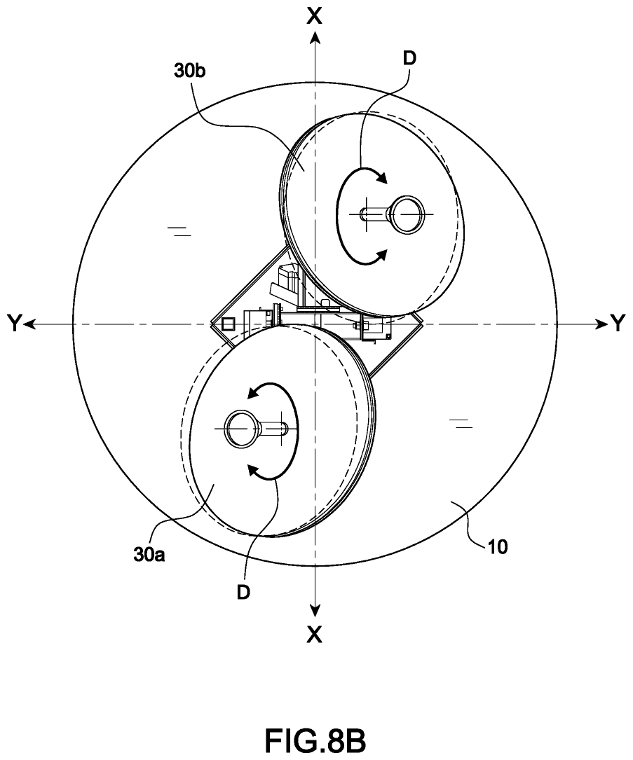

Referring to FIGS. 5, 8A and 8B, a set of polarization adjustment device 60, formed by a first polarization adjustment device 60A and a second polarization adjustment device 60B which are respectively arranged above the first arm 31a and the second arm 31b, wherein the first polarization adjustment device 60A includes: a supporting seat 61, which is a hollow body and the inner end is fixed on the upper end of the first arm 31a; a fifth motor 62, arranged at the bottom of the supporting seat 61, a rotating shaft of the fourth motor 62 is extended into the supporting seat 61 and connected to a fifth belt wheel 63, the fifth belt wheel 63 drives a fifth belt wheel 64, the fifth belt wheel 64 is able to rotate on a shaft center 5, and its upper end 641 protrudes above the supporting seat 61, then drives the first disk antenna 30a to rotate as D shown in the drawing. And the second polarization adjustment device 60B is arranged above the second arm 31b, which has the same structure as the first polarization adjustment device 60A, and is used to drive the second disk antenna 30b to rotate. The present invention uses the polarization adjustment device 60 to adjust polarization of the first disk antenna 30a and the second disk antenna 30b, as D shown in FIGS. 3, 8A and 8B, this is the fourth means of the present invention.

Whereby the four means above-mentioned forming a mechanism type antenna for tracking starlink satellite 70A, which can control the first disk antenna 30a and the second disk antenna 30b to achieve handover tracking of the orbit of the starlink satellites, and can simultaneously adjusting the horizontal shaft A, the elevation angle C and the polarization D for receiving the signal from the starlink satellite. Of course, as shown in FIG. 9, the mechanism type antenna for tracking starlink satellite 70B forming by two rectangular disk antennas 300a, 300b can also achieve the same purpose.

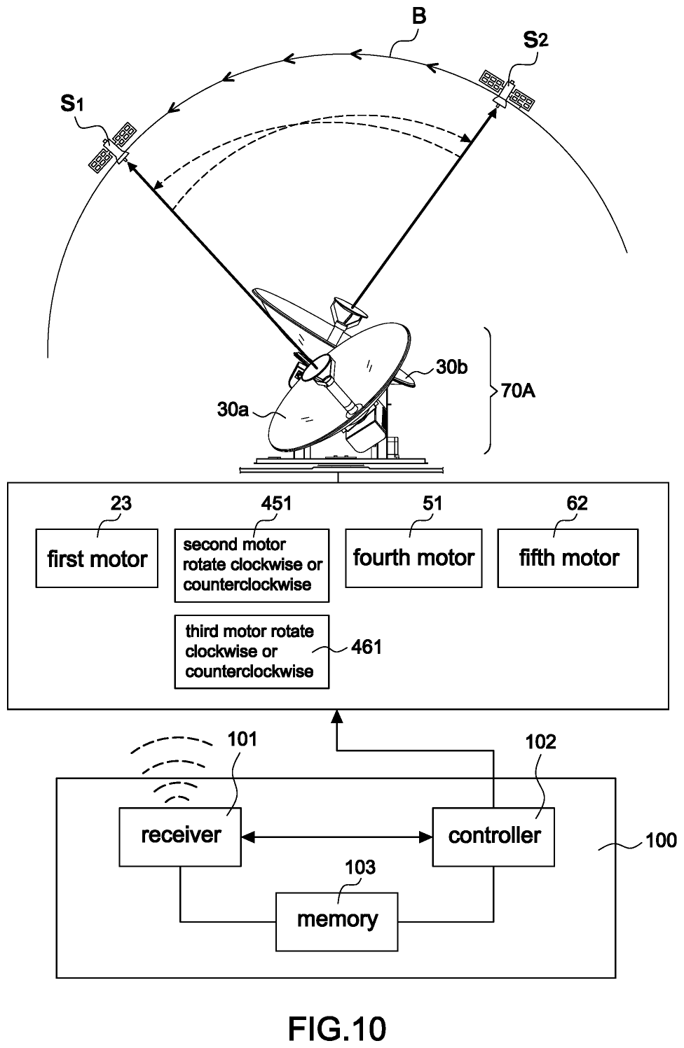

Referring to FIG. 10, the present invention further includes an antenna control device 100, which can receive ephemeris information from satellites S1 and S2, and control the mechanism type antenna for tracking starlink satellite 70A based on the ephemeris information. The ephemeris information may include information such as azimuth angles and elevation angles of satellites S1 and S2. In addition, although the antenna control device 100 is shown separately from the mechanism type antenna for tracking starlink satellite 70A, the antenna control device 100 may also be embodied in the antenna 70A as required.

In this embodiment, the antenna control device 100 may include a receiver 101 and a controller 102, the receiver 101 may receive satellite S1 and S2 ephemeris information, and may also include a memory 103, and the ephemeris information may be pre-stored in memory 103. The ephemeris information may include information about the orbits on which the satellites S1 and S2 move hourly, and the receiver 101 may output the received ephemeris information to the controller 102. In addition, the receiver 101 can store the received ephemeris information in the memory 103, the controller 102 can include a single processor or multiple processors, and it can use the processor to process the ephemeris information, thereby controlling the mechanism type antenna for tracking starlink satellite. However, the reception of the antenna control device 100 and the ephemeris information is a prior art, and is not the subject of the patent of the present invention, so it will not be mentioned in detail here.

The present invention mainly utilizes the controller 102 to process the data received by the receiver 101 and the data stored in the memory 103, and then the controller 102 can generate the control signal to control the mechanism type antenna for tracking starlink satellite 70A. Which means, the controller 102 can respectively control the rotation of the first motor 23, the second motor 451, the third motor 461, the fourth motor 51, and the fifth motor 62 to adjust the elevation angle, the oblique angle, the azimuth angle and the polarization, etc. of the mechanism type antenna for tracking starlink satellite 70A. Wherein, the important feature is that by controlling the forward rotation or reverse rotation of the second motor 451, the third motor 461, the first disk antenna 30a and the second disk antenna 30b can be synchronously controlled, and the cross swing is reversely symmetrical, so as to handover tracking the satellites S1, S2 . . . and so on in the starlink satellite orbit B, and can adjust the horizontal shaft, elevation angle and polarization at the same time, so as to achieve fast and accurate reception of starlink satellite signals.

Whereby the present invention uses two disk antennas that 180° rotational symmetrically swing in opposite direction to form a mechanism type antenna which can quickly handover to new target satellites, which can replace the two independent conventional antennas currently used by VSTA and the electronically phased array antenna of starlink system, so as to achieve cost down and reduce failure rate.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mechanism type antenna for tracking starlink satellite, comprising:
a base, having a center shaft arranged vertically on the base;
a horizontal shaft adjustment device, arranged on the base, including: a swivel seat, the bottom of the swivel seat is connected to a first belt wheel and set on the center shaft; a first motor, arranged on the swivel seat, a rotate shaft of the first motor drives the first belt wheel through a first driving belt, and then drives the swivel seat to rotate clockwise or counterclockwise on the central shaft;
a starlink satellite orbit adjustment device, arranged on the swivel seat, a vertical rack, a first shaft seat and a second shaft seat arranged on the longitude direction of front end and rear end of the vertical rack, on the first shaft seat and the second shaft seat having a first rotation shaft and a second shaft respectively, then the first rotation shaft and the second shaft are connected to each other by a bearing seat, the longitude length is larger than the transverse width of the bearing seat, making the bearing seat enable to swing left and right along with the rotation of the second shaft; moreover, at the middle of the bearing seat having a transverse shaft, the left and right ends of the transverse shaft set trough the bearing seat and fixed on the bearing seat, then respectively connect to a second belt wheel and a third belt wheel; a set of disk antenna, formed by a first disk antenna and a second disk antenna which are 180° rotational symmetrically arranged on the left and right sides of the bearing seat, which are respectively drove by a first arm and a second arm, the first arm and the second arm are respectively connected and secured to a second belt wheel and a third belt wheel, the second belt wheel and the third belt wheel are drove by a second motor and a third motor through a second driving belt and a third driving belt, so as to make the first arm and the second arm which are respectively connected and secured on the second belt wheel and the third belt wheel to rotate on the left and right ends of the transverse shaft, then further drive the first disk antenna and the second disk antenna swing forth and back on the bearing seat, so as to achieve handover tracking to low orbit satellite; an elevation angle adjustment device, arranged a vertical rack, including: a fourth motor, a fourth belt wheel arranged on the second rotation shaft, and the fourth motor drives the fourth belt wheel through a fourth driving belt, and then with the first rotation shaft and second rotation shaft as center drives the bearing seat swing left and right to adjust the elevation angle of the first disk antenna and the second disk antenna; and
a set of polarization adjustment device, formed by a first polarization adjustment device and a second polarization adjustment device which are respectively arranged above the first arm and the second arm, wherein the first polarization adjustment device includes: a supporting seat, which is a hollow body and the inner end is fixed on the upper end of the first arm; a fifth motor, arranged at the bottom of the supporting seat, a rotating shaft of the fifth motor is extended into the supporting seat, a fifth driving belt drives a fifth belt wheel, the fifth belt wheel is able to rotate on a shaft center, and its upper end protrudes above the supporting seat, then drives the first disk antenna to rotate; and the second polarization adjustment device which has the same structure as the first polarization adjustment device, and is used to drive the second disk antenna to rotate;
Whereby achieve a mechanism type antenna for tracking starlink satellite, which can control the first disk antenna and the second disk antenna to achieve handover tracking of low orbit starlink satellites, and can simultaneously adjusting the horizontal shaft, the elevation angle and the polarization for receiving the signal from the starlink satellite.

2. The mechanism type antenna for tracking starlink satellite as claimed in claim 1, the second motor and the third motor are respectively arranged on the first arm and the second arm.

3. The mechanism type antenna for tracking starlink satellite as claimed in claim 1, the fourth motor is arranged on the second shaft seat.

4. The mechanism type antenna for tracking starlink satellite as claimed in claim 1, wherein further includes a receiver, a controller and a memory, using the controller to process the data received from the receiver and the data storage in the memory, and then produces the control signal that is used to control the mechanism type antenna for tracking starlink satellite to respectively control the first motor, the second motor, the third motor, the fourth motor and the fifth motor to rotate, so as to control the elevation angle, oblique angle, azimuth angle and polarization of the mechanism type antenna for tracking starlink satellite.

5. The mechanism type antenna for tracking starlink satellite as claimed in claim 1, wherein the first disk antenna and the second disk antenna include: rectangular, circular or elliptical type.
